(19) United States
(12) Patent Application Publication
(10) Pub. No.: US 2004/0028302 A1
(43) Pub. Date: Feb. 12, 2004

(54) Ball-and-socket joint

(75) Inventors: Olaf Abels, Belm (DE); Klaus Broker, Bohmte-Hunteburg (DE)

Correspondence Address: McGLEW AND TUTTLE, John James McGlew, Scaborough Station, Scarborough, NY, 10510-0827, US

(73) Assignee: ZF Lemforder Metallwaren AG

(21) Appl. No.: 10/632,017

(22) Filed: Jul. 31, 2003

Related U.S. Application Data
(63) Continuation of application No. 09/700,598, filed on Jan. 8, 2001, now abandoned.
Application No. 09/700,598 is a 371 of international application No. PCT/DE00/00669, filed on Mar. 7, 2000.

(30) Foreign Application Priority Data
Mar. 17, 1999 (DE) 199 11 770.5

(51) Int. Cl. F16C 33/74; F16C 23/04; F16C 23/08; F16C 25/04

(52) U.S. Cl. 384/206; 384/145

(57) ABSTRACT

A ball-and-socket joint is disclosed with a housing 1 a bearing shell 2 inserted into same, a ball pivot 3, whose joint ball 3.1 is mounted in the bearing shell movably in all directions, and a sealing bellows 4 between the housing and the ball pivot. A sliding ring 6 receiving the pivot-side edge area 4.1 of the sealing bellows 4 is inserted into a ball race 5 fixed on the ball pivot 3.

### RELATED APPLICATION

This application is a continuation of application Ser. No. 09/700,598 filed Nov. 16, 2000.

### FIELD OF THE INVENTION

The present invention pertains to a ball-and-socket joint with a housing, a bearing shell inserted into the housing, a ball pivot with a joint ball mounted in the bearing shell movably in all directions, and a sealing bellows between the housing and the ball pivot.

### BACKGROUND OF THE INVENTION

Such ball-and-socket joints are used, e.g., for wheel suspensions of motor vehicles. The general design is almost always the same. For example, prior-art ball-and-socket joints comprise a housing and a bearing shell inserted therein. The bearing shell receives, with its inner spherical bearing surface, the joint ball of a ball pivot movably in all directions. To seal the ball-and-socket joint components, which are movable in relation to one another, against the environment, a sealing bellows is inserted between the housing and the ball pivot.

A ball-and-socket joint of this type is shown, e.g., in DE 36 32 265 C1. The sealing bellows arranged between the housing and the ball pivot is fixed with its pivot-side edge area on the ball pivot only partially in a retaining ring having an L-shaped cross section. The drawback of a design according to DE 36 32 265 C1 is, however, that the fixed sealing bellows is directly in contact with its outer surface with the motor vehicle component and friction is thus generated during movements of the ball-and-socket joint as a consequence of the relative movement between the sealing bellows and the motor vehicle component, and this friction damages the surface of the sealing bellows and compromises the sealing function of the bellows over a long life cycle or destroys the bellows altogether. This implies the risk that the sealing bellows will age and will be worn prematurely and the joint as a whole may thus possibly fail.

Moreover, a retaining ring, which is arranged tightly on the ball pivot and slidingly receives the edge of the sealing bellows, has been known from SUI-PS 465 971.

### SUMMARY AND OBJECTS OF THE INVENTION

The basic technical object of the present invention is to design the component pair “ball pivot-sealing bellows” such that compensation of the movements generated in the joint is made possible with the slightest friction possible without the sealing bellows becoming worn or destroyed.

According to the invention, a ball-and-socket joint is provided comprising a housing, a bearing shell inserted into same, a ball pivot, whose joint ball is mounted in the bearing shell movably in all directions, and a sealing bellows between the housing and the ball pivot. A sliding ring receiving the pivot-side edge area of the sealing bellows is slidingly inserted into a ball race fixed on the ball pivot.

The present invention consequently provides a ball race seated tightly on the ball pivot. The sliding ring receives the pivot-side edge area of the sealing bellows and is slidingly received in this ball race.

A friction-optimized pairing, which receives the edge area of the sealing bellows and thus makes possible the compensation of all the movements performed by the sealing bellows in the ball-and-socket joint without destruction of or damage to the sealing bellows, is achieved between the ball race and the sliding ring due to a solution according to the present invention.

In another embodiment of a ball-and-socket joint according to the present invention, the inner side of the sliding ring cooperating with the edge area of the sealing bellows is provided, at least in some areas, with a collar. This collar is preferably made in one piece with the inside of the sliding ring, so that this can be manufactured as a one-piece component. The collar in turn engages a complementary contour in the edge area of the sealing bellows. As a result, a “clamping effect” is achieved in a simple and advantageous manner. This clamping effect presses the edge area of the sealing bellows against the ball race under pretension, so that sufficient sealing is also guaranteed at the same time, besides the sliding function of the edge area of the sealing bellows. The sliding ring may have an approximately L-, T- or F-shaped cross section.

To reduce the sliding friction between the sliding ring and the ball race, it is, moreover, suggested according to the present invention that if a sliding ring having an approximately L-shaped cross section is used, which correspondingly comprises an axial leg and a radial leg, a sliding connection be established only between the radial leg and the inner surface of the ball race. There is a gap between the axial leg and the inner surface of the ball race, which inner surface is associated with the axial leg. Due to such a solution only very small surfaces are in contact with one another, which makes it possible to specifically influence the friction parameters. The ball race may in turn have a U-shaped or likewise L-shaped cross section. Depending on the requirements on the sliding friction partners and the sealing of the entire system, it is, moreover, possible for at least one surface of the edge area of the sealing bellows to be directly slidingly in contact with the inner surface of the ball race. Corresponding to the solution being presented here, this contact pairing may comprise a sealing lip of the edge area of the sealing bellows or it may be a labyrinth seal formed with the inner surface of the ball race.

The labyrinth seal, between the inner surface of the ball race and the edge area of the sealing bellows, as well as the sealing lip, are alternative solutions, which may, of course, also be used together. This means that, e.g., a surface of the edge area of the sealing bellows has a sealing lip, and this sealing lip acts against the inner surface of the ball race, and another, second surface of the edge area of the sealing bellows forms a labyrinth seal together with the inner surface of the ball race. The sliding ring now assumes the function of pretensioning the edge area of the sealing bellows in the corresponding axial or radial direction against the surface to be sealed. A reduced diameter of the sealing bellows may have a supporting effect in this case. The sliding ring may be manufactured as a shaped sheet metal part or plastic molding in a simple manner and inexpensively. This also applies to the ball race.

According to another embodiment, the sliding ring may have according to the present invention at least one slot. In the case of a slotted design of the sliding ring, the sliding ring is briefly widened during mounting and is subsequently snapped into the ball race.

In another embodiment according to the present invention, the ball race has lugs located at spaced locations from one another. The sliding ring is pushed onto the ball race in such an embodiment, the lugs of the ball race are subsequently deformed in the radial direction and thus they receive the sliding ring together with the edge area of the sealing bellows within the ball race.

Sealing of the component pairing “ball pivot-sealing bellows” can be achieved with a ball-and-socket joint according to the present invention in the obvious manner in the axial direction, in the radial direction as well as in the axial and radial directions. For reasons of stability, it is advantageous here for the pivot-side edge area of the sealing bellows to form a thickened material bead, which acts with an elastic pretension against the ball race and/or against the sliding ring. Reduced friction was achieved with a ball-and-socket joint according to the present invention between the sealing bellows and the ball pivot. The sealing bellows can no longer twist during movements of the joint and is therefore also not worn and destroyed as a consequence of the harmful tensile stresses generated-by the twisting, unlike in the case of the prior-art designs. The pretension between the sliding ring and the ball race can be selected in a very simple manner and accurately, so that the friction parameters and consequently the behavior of the friction partners can be accurately predetermined.

The sliding ring can thus form both a detachable connection with the edge area of the sealing bellows and be vulcanized directly on the edge area of the sealing bellows or be fastened to this edge area in the known manner or be integrated in this edge area.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a sectional view showing an embodiment of the component pairing ball pivot-sealing bellows edge area according to the present invention;

FIG. 2 is a sectional view showing another embodiment of the component pairing ball pivot-sealing bellows edge area according to the present invention;

FIG. 3 is a detail sectional view along line III-III according to FIG. 1;

FIG. 4 is a detail sectional view along line IV-IV according to FIG. 6;

FIG. 5 is a sectional view showing another embodiment of the component pairing ball pivot-sealing bellows edge area according to the present invention;

FIG. 6 is a sectional view showing another embodiment of the component pairing ball pivot-sealing bellows edge area according to the present invention;

FIG. 7 is a sectional view showing another embodiment of the component pairing ball pivot-sealing bellows edge area according to the present invention;

FIG. 8 is a detail sectional view along line VIII-VIII according to FIG. 7;

FIG. 9 is a sectional view showing another embodiment of the component pairing ball pivot-sealing bellows edge area according to the present invention; and

FIG. 10 is a partial sectional view of the ball joint.

### DESCRIPTION OF THE PREFERRED EMBODIMENTS

Referring to the drawings in particular, a ball pivot 3 has a joint ball 3.1 inserted into a housing 1 having a bearing shell 2 to form the ball-and-socket joint. A ball race 5 of U-shaped cross section is placed on the ball pivot 3. The snug fit of the ball race 5 on the ball pivot 3 is preferably achieved by means of a force fit. A sliding ring 6 of L-shaped cross section is inserted into the ball race 5 having a U-shaped cross section. The sliding ring 6 has an axial extension formed as an axial leg 6.3 and a radial extension formed as a radial leg 6.4. The edge area 4.1 of the sealing bellows 4 is received between these legs. A surface of the edge area 4.1 of the sealing bellows 4 is in direct sliding contact with the inner surface of the ball race 5. This connection represents a labyrinth seal 4.3, 5.1 at the same time. On the contact side of the radial leg 6.4 of the sliding ring 6, the ball race 5 has lugs 5.2. These lugs, directed in the axial direction before the mounting of the sliding ring, are deformed after the insertion of the sliding ring 6 into the ball race 5, so that a sliding pair is formed between the ball race 5 and the sliding ring 6.

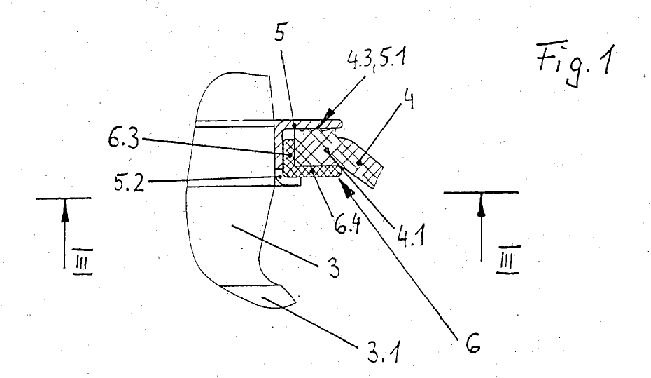

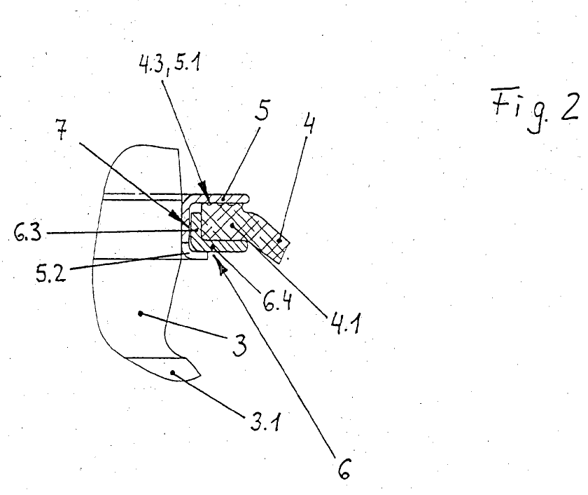

FIG. 2 shows once again a component pairing between the ball pivot 3 and the edge area 4.1 of the sealing bellows, which has essentially the same design as that shown in FIG. 1. However, the sliding ring 6 with its axial leg 6.3 is not in sliding contact with the inner surface of the ball race 5 in the embodiment according to FIG. 2 according to the present invention. There is rather a gap 7 between the axial leg 6.3 of the sliding ring 6 and the inner surface of the ball race 5. The sliding ring 6 is thus in contact with the lugs 5.2 of the ball race 5 with its radial leg 6.4 in some areas only. The surfaces between the ball race 5 and the sliding ring 6, which surfaces are in contact with one another, are very small in such a design, so that a considerable reduction in friction can be achieved hereby.

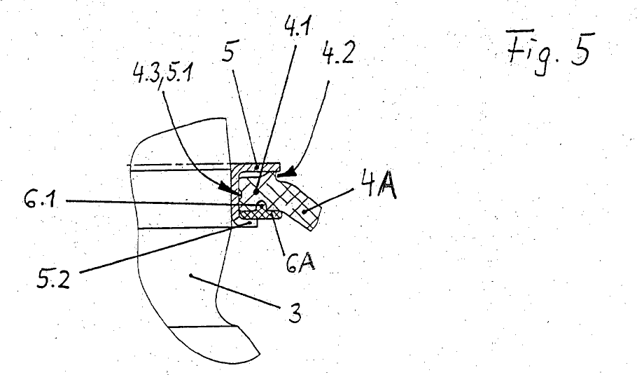

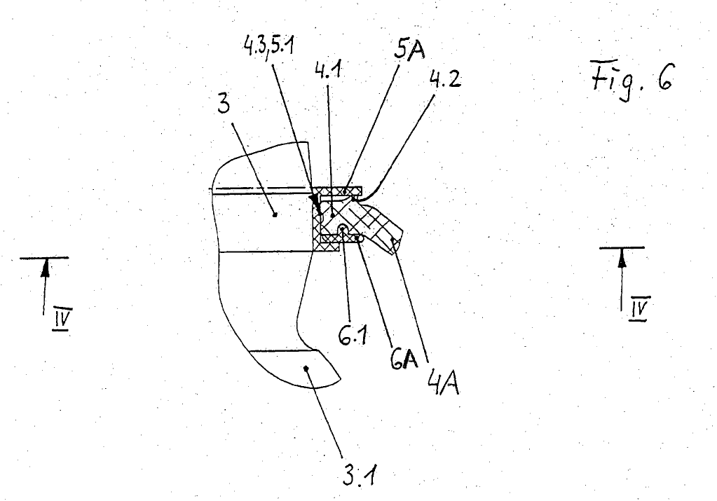

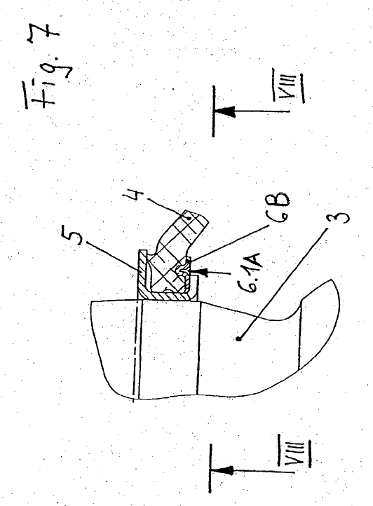

The embodiments of a ball-and-socket joint according to the present invention shown graphically in FIGS. 5 and 6 have some peculiarities. Thus, the ball race 5 and 5A has again a U-shaped cross section, but the sliding ring 6A has a disk-shaped design in the embodiment of FIG. 5. The axial extension is formed as a collar 6.1 is made in one piece with the sliding ring 6A approximately centrally on the side facing the edge area 4.1 of the sealing bellows 4A. This collar directly engages the edge area 4.1 of the sealing bellows 4A and thus makes it possible to press the edge area against the inner surface of the ball race under pretension. Furthermore, the edge area 4.1 of the sealing bellows 4A has a sealing lip 4.2, which is in contact with a first inner surface of the ball race 5/5A and assumes a sealing function during movements of the sealing bellows as a consequence of its stripping effect. Moreover, a wave-shaped contour 4.3 is provided on another surface of the edge area 4.1 of the sealing bellows 4A. This wave-shaped contour 4.3 cooperates with an inner surface 5.1 of the ball race 5/5A, which said inner surface 5.1 has a complementary shape and forms a labyrinth seal 4.3, 5.1.

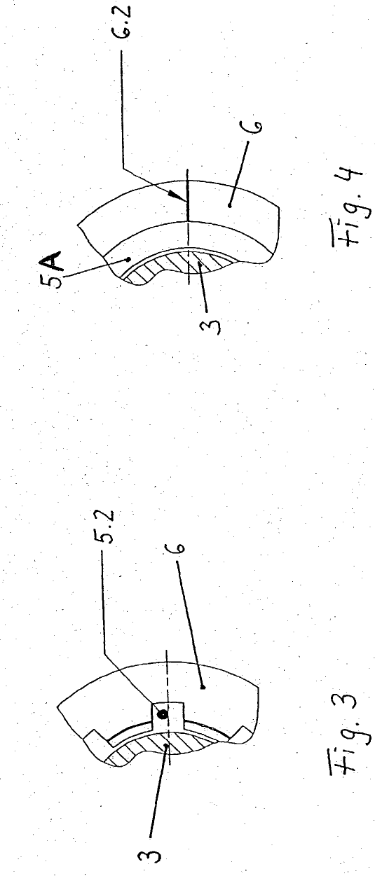

In the embodiment according to FIG. 6, the sliding ring 6A is additionally slotted. This means that it is snapped onto the ball race 5A during the mounting. This is shown in the section IV-IV from FIG. 6, which is shown in FIG. 4. The section III-III corresponding to FIG. 1 is shown in FIG. 3. The lugs 5.2 can be recognized here.

As can be recognized from FIGS. 1, 2, 5 and 6, both the ball race 5/5A and the sliding ring 6 or 6A may be manufactured optionally from metal or plastic or metal-plastic composites.

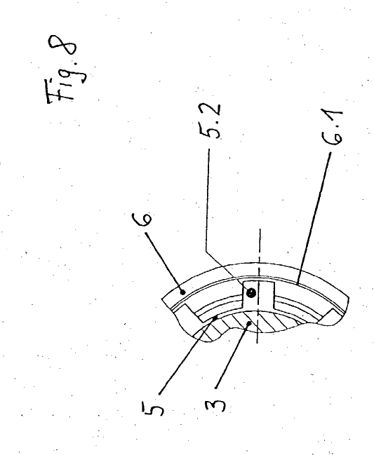

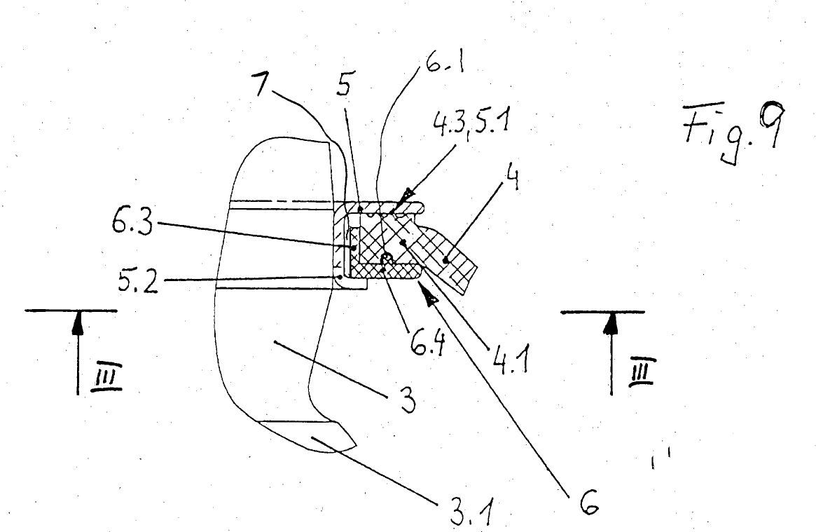

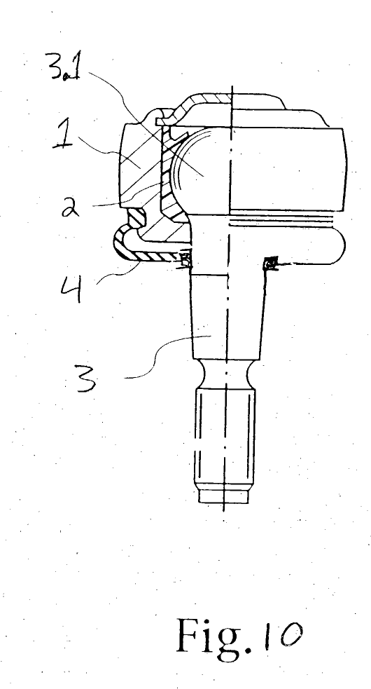

The variant of a ball-and-socket joint according to the present invention as shown in FIG. 7, which has basically the same design as the embodiments shown in FIGS. 5 and 6, has the difference that the sliding ring 6B consists of a sheet metal part manufactured by shaping and embossing. The connection of this sliding ring 6B to the ball race 5 is shown in the sectional view in FIG. 8 corresponding to the section VIII-VIII from FIG. 7. Lugs 5.2 of the ball race 5 are again used in the above-described manner to fix the edge area 4.1 of the sealing bellows 4A as well as the sliding ring 6B. The collar 6.1A is formed by a material fold.

FIG. 9 shows still another embodiment of the component pairing ball pivot-sealing bellows edge area according to the present invention. A ball race 5 of U-shaped cross section is placed on the ball pivot 3. The snug fit of the ball race 5 on the ball pivot 3 is preferably achieved by means of a force fit. A sliding ring 6 of L-shaped cross section is inserted into the ball race 5 having a U-shaped cross section. The sliding ring 6 has an axial leg 6.3 and a radial leg 6.4. A collar 6.1 is made in one piece with the sliding ring 6 approximately centrally on the side facing the edge area 4.1 of the sealing bellows 4. This collar directly engages the edge area 4.1 of the sealing bellows 4 and thus makes it possible to press the edge area against the inner surface of the ball race under pretension. The edge area 4.1 of the sealing bellows 4 is received between these legs. A surface of the edge area 4.1 of the sealing bellows 4 is in direct sliding contact with the inner surface of the ball race 5. This connection presents a labyrinth seal 4.3, 5.1 at the same time. On the contact side of the radial leg 6.4 of the sliding ring 6, the ball race 5 has lugs 5.2. These lugs, directed in the axial direction before the mounting of the sliding ring 6, are deformed after the insertion of the sliding ring 6 into the ball race 5, so that a sliding pair is formed between the ball race 5 and the sliding ring 6.

While specific embodiments of the invention have been shown and described in detail to illustrate the application of the principles of the invention, it will be understood that the invention may be embodied otherwise without departing from such principles.

In the claims:

1. A ball-and-socket joint, comprising:
a housing;
a bearing shell inserted into said housing;
a ball pivot with a joint ball mounted pivotally in all directions in said bearing shell;
a sealing bellows between the housing and the ball pivot, said sealing bellows having a pivot-side edge area;
a ball race fixed on said ball pivot; and
a sliding ring receiving said pivot-side edge area of said sealing bellows, said sliding ring being slidingly mounted in said ball race and having a sliding face facing the joint ball arranged adjacent to the ball race.

2. A ball-and-socket joint in accordance with claim 1, wherein:
said sliding ring includes a collar made in one piece with said sliding ring.

3. A joint in accordance with claim 2, wherein:
said collar engages said pivot-side edge area of said sealing bellows.

4. A joint in accordance with claim 2, wherein:
said collar is made in one piece with an inner side of said sliding ring, said sliding ring cooperates with said pivot-side edge area of said sealing bellows in at least some areas.

5. A joint in accordance with claim 1, wherein:
said sliding ring includes an axial extension and a radial extension.

6. A joint in accordance with claim 1, wherein:
said race and said sliding ring define a gap between said race and said sliding ring.

7. A joint in accordance with claim 5, wherein:
said race and said sliding ring define a gap between said axial extension and a surface of said ball race.

8. A ball-and-socket joint in accordance with claim 7, wherein:
said sliding ring has an approximately L-shaped cross section comprising an axial leg as said axial extension and a radial leg as said radial extension, said radial leg is in sliding contact with an inner surface of said ball race.

9. A ball-and-socket joint in accordance with claim 1, wherein:
said ball race has an approximately U-shaped cross section.

10. A ball-and-socket joint in accordance with claim 1, wherein:
said sealing bellows has a surface slidingly in contact with a surface of said ball race.

11. A ball-and-socket joint in accordance with claim 10, wherein:
said surface of said sealing bellows which is in contact with said surface of said ball race has a sealing lip in contact with said surface of said ball race.

12. A ball-and-socket joint in accordance with claim 10, wherein:
said surface of said sealing bellows which is in contact with said surface of said ball race forms a labyrinth seal together with said surface-of said ball race.

13. A ball-and-socket joint in accordance with claim 10, wherein:
said surface of said sealing bellows which is in contact with said surface of said ball race has a sealing lip and a second surface of said sealing bellows forms a labyrinth seal together with said surface of said ball race.

14. A ball-and-socket joint in accordance with claim 5, wherein:
said sliding ring is a shaped sheet metal part or a plastic molding;
said sliding ring receives and holds a portion of said sealing bellows between said radial and axial extensions;
said radial and axial extensions are substantially perpendicular to each other;
said ball race is fixed to said ball pivot.

15. A ball-and-socket joint in accordance with claim 1, wherein:
said ball race has a leg which is in contact with said sliding ring, said leg comprising lugs arranged at spaced locations from one another.

16. A ball-and-socket joint in accordance with claim 1, wherein:
said sliding ring has at least one radially extending slot.

17. A ball-and-socket joint in accordance with claim 1, wherein:
said pivot-side edge area of said sealing bellows forms a thickened material bead, which is pressed against said ball race or said sliding ring with an elastic pretension.

18. A joint in accordance with claim 1, wherein:
said sliding ring has a disk shape.

19. A joint in accordance with claim 1, wherein:
said sliding ring is slotted.

20. A ball-and-socket joint in accordance with claim 1, wherein:
said sliding ring has an approximately L shaped cross section.

21. A ball-and-socket joint in accordance with claim 1, wherein:
said sliding ring has an approximately T shaped cross section.

22. A ball-and-socket joint in accordance with claim 1, wherein:
said sliding ring has an approximately F shaped cross section.

23. A ball-and-socket joint in accordance with claim 1, wherein:
said sliding ring is vulcanized directly to said pivot-side edge area of said sealing bellows.

24. A ball-and-socket joint sealing connection for a joint having a housing, a bearing shell inserted into the housing and a ball pivot with a joint ball mounted movably in all directions in the bearing shell, the joint sealing connection comprising:
a sealing bellows connected between the housing and the ball pivot, said sealing bellows having a pivot-side edge area;
a ball race fixed on said ball pivot; and
a sliding ring receiving the pivot-side edge area of said sealing bellows, said sliding ring including an axial extension and a radial extension, said sliding ring being slidingly connected to said ball race and having a sliding face facing the joint ball arranged adjacent to the ball race.

25. A ball-and-socket joint, comprising:
a housing;
a bearing shell arranged in said housing
a ball pivot with a joint ball mounted pivotally in said bearing shell;
a sealing bellows arranged between said housing and said ball pivot, said sealing bellows including a pivot-side edge area;
a race fixed on said ball pivot; and
a sliding ring receiving said pivot-side edge area of said sealing bellows, said sliding ring being slidingly arranged in said race.

26. A joint in accordance with claim 25, wherein:
said sliding ring has a sliding face facing the joint ball and arranged adjacent to said race, said sliding face of said ring sliding around said race.

27. A joint in accordance with claim 25, wherein:
said sliding ring is rotatable around said race and said ball pivot.
